(19) United States
(12) Patent Application Publication
(10) Pub. No.: US 2015/0061480 A1
(43) Pub. Date: Mar. 5, 2015

(54) Piece Of Furniture Having At Least One Drawer Or The Like Provided With Ejecting Means

(71) Applicant: ARTURO SALICE S.P.A., Novedrate (IT)

(72) Inventor: Luciano Salice, Carimate (como) (IT)

(73) Assignee: Arturo Salice S.p.A., Novedrate (como) (IT)

(21) Appl. No.: 14/357,246

(22) PCT Filed: May 20, 2013
(86) PCT No.: PCT/EP2013/060327

§ 371 Date: May 9, 2014

(30) Foreign Application Priority Data
Jul. 31, 2012 (IT) MI2012A001333

(51) Int. Cl. A47B 88/04; E05B 65/44

(52) U.S. Cl. CPC A47B 88/0481; E05B 65/44
USPC 312/319.1

(57) ABSTRACT

The piece of furniture (10) having at least one drawer (13) or the like comprises a first and a second wall (11, 12) laterally arranged to the drawer (13) and provided with respective pull-out guides (14, 15) for the drawer, and ejecting means (16; 42) conformed and arranged for generating a thrust in an opening direction on the drawer (13), the ejecting means (16; 42) being lockable in a closing position of the drawer by means of releasable locking means (21, 22; 44, 46); the ejecting means (16; 42) with the relevant locking means (21, 22; 44, 46) are provided at only one (11) of the walls (11, 12) of the piece of furniture (10) laterally arranged to the drawer (13).

### BACKGROUND OF THE INVENTION

The invention concerns a piece of furniture having at least one drawer or the like wherein there are provided ejecting means for the drawer.

### STATE OF THE ART

In the furnishings sector, furniture having drawers without handles or similar gripping means is frequently used, in such cases, the furniture must be provided with suitable lockable ejecting means for the purposes of opening the drawers. Following a slight thrust on the closed drawer on the part of the user, the ejecting means are released and generate movement of the drawer in an opening direction by a first section sufficient for the user to grasp it and thus open it completely. Such ejecting means are conventionally arranged on each wall of the piece of furniture, which are located at the respective sides of the drawer. Yet, with an arrangement such as this, optimal operation of the ejecting system for drawer opening is achieved only in the case of drawers of a limited width. In the case of very wide drawers, the user must instead press a central area of the front part of the drawer.

In fact, in cases in which the user presses a lateral area of the front part of the drawer, there is a risk that only the ejecting means located on that same side is released and that the ejecting means on the opposite side remains locked, leading to faulty opening and misalignment of the drawer, if not actual breakage of the ejecting means.

With the aim of overcoming this drawback, the application of synchronizing devices has been proposed in various manners. Some of these devices comprise a connecting bar having gears at the ends thereof for engagement with respective racks to obtain parallel movement on both sides of the drawer and thus synchronization between the ejecting means arranged on the two sides of the drawer.

A solution such as this proves to be complex in terms of construction, difficult to mount, and it involves substantial changes with respect to the ejecting means and/or the pull-out guides of drawers without such synchronization devices, with a consequent increase in costs.

In a piece of furniture having at least one drawer or the like, there is thus a need to have ejecting means configured in such a manner as to overcome the above-mentioned drawback, while maintaining a high level of simplicity as regards construction, and limited costs.

### AIM OF THE INVENTION

The aim of the present invention is therefore to provide a piece of furniture with at least one drawer of the like, wherein there are provided simply-constructed, economical and easy-to-mount ejecting means that are configured in such a manner as to prevent partial or faulty opening of the drawer.

### BRIEF DESCRIPTION OF THE INVENTION

The above is achievable by means of a piece of furniture having at least one drawer or the like pullable out from the body of the piece of furniture, the piece of furniture comprising:
a first and a second wall laterally arranged to the drawer, respectively provided with a first and a second pull-out guide for said drawer, and,
ejecting means conformed and arranged for generating a thrust in an opening direction on the drawer, said ejecting means being lockable in a closed position of the drawer by means of releasable locking means,
   characterized in that said ejecting means with the relevant locking means are provided at only one of said walls laterally arranged to the drawer.

Preferably, retaining means are provided at the other one of said walls laterally arranged to the drawer, said retaining means being conformed and arranged for retaining said drawer in the closing position.

Further characteristics of the present invention are also defined in the claims below.

### BRIEF DESCRIPTION OF THE DRAWINGS

The characteristics and advantages of the present invention will emerge more clearly from the following description of preferential but not exclusive embodiments of the piece of furniture having a drawer or the like, with reference to the accompanying figures, wherein:

FIG. 1 is a plan view of the piece of furniture with a drawer, according to a first embodiment of the present invention;

FIG. 2 is a plan view of the ejecting means and the retaining means of the first embodiment appearing in FIG. 1, in the closing position of the drawer;

FIG. 3 is an enlarged partial view of the ejecting means appearing in FIG. 2, with the cover removed;

FIG. 4 is a plan view of the ejecting means and the retaining means appearing in FIG. 1, in the pressed position of the drawer for the purpose of releasing the ejecting means;

FIG. 5 is an enlarged partial view of the ejecting means appearing in FIG. 4, with the cover removed;

FIG. 6 is a plan view of the ejecting means and the retaining means appearing in FIG. 1, in which the released ejecting means have caused the drawer to open by a first section;

FIG. 7 is a second embodiment of the retaining means according to the present invention; and

FIG. 8 is a different embodiment of the ejecting means according to the present invention, further provided with closing means for the drawer.

### DETAILED DESCRIPTION OF THE INVENTION

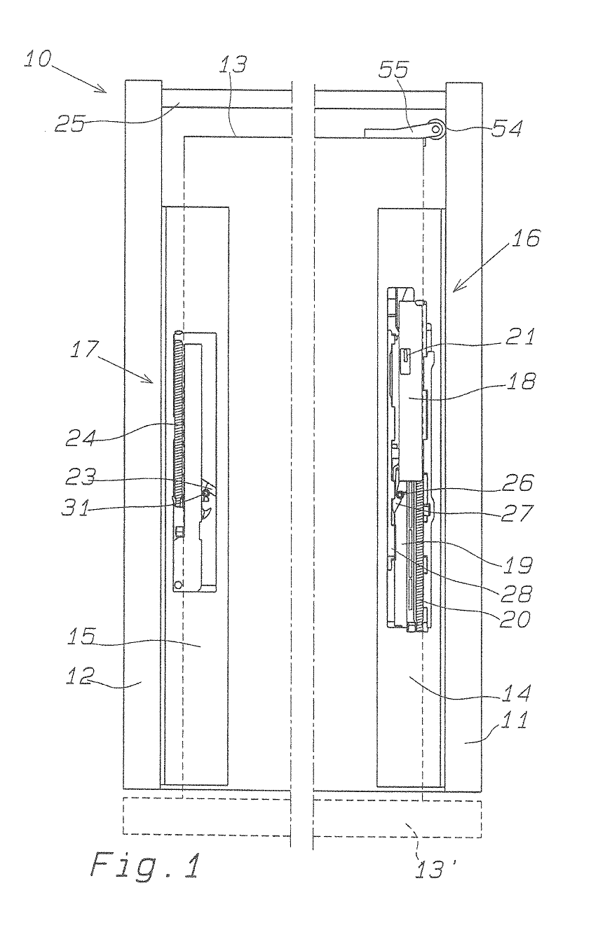

A piece of furniture with a drawer or the like is illustrated in FIG. 1 according to a first embodiment of the present invention, and indicated in its entirety by the reference numeral 10; this piece of furniture has a body comprising a first 11 and a second 12 wall laterally arranged to the drawer 13, respectively provided with a first 14 and a second 15 pull-out guide for the drawer 13. For greater clarity, the drawer 13 is illustrated in a see-through view with a dashed line, so as to make the guides and the ejecting and retaining devices visible.

As the drawer 13 is without a handle or a similar gripping means, for the purposes of opening the drawer 13, the piece of furniture also provides ejecting means 16 conformed and arranged for generating a thrust in an opening direction on the drawer 13. The ejecting means 16 are lockable in a closing position of the drawer 13 by means of locking means that are releasable by pressing the drawer in the closing direction, as explained below.

According to the present invention, the ejecting means 16 with the relevant locking means are provided at only one 11 of the walls 11, 12 of the piece of furniture 10 laterally arranged to the drawer, whereas at the other one 12 of the walls 11, 12 laterally arranged to the drawer 13, there are preferably provided retaining means 17 conformed and arranged for retaining the drawer in the closing position, and releasable by means of a suitable force in the opening direction of the drawer.

In the preferential embodiment illustrated, the ejecting means 16 with the relevant locking means are applied to the pull-out guide 14, particularly to the fixed part thereof, which is mounted on the wall 11 of the piece of furniture where the means 16 is arranged.

As an alternative, the ejecting means 16 with the relevant locking means can be applied directly to the wall 11 of the piece of furniture or to a first lateral wall of the drawer 13.

According to the same preferential embodiment illustrated, the retaining means 17 are applied to the pull-out guide 15, particularly to the fixed part thereof, provided on the other wall 12, laterally arranged to the drawer 13.

Alternatively, the retaining means 17 may be applied directly to the other wall 12 of the piece of furniture, laterally arranged to the drawer 13 or to a second side wall of the drawer 13.

With the aim of enabling efficient opening of the drawer 13, the retaining means 17 are configured for exerting a retaining action in the closing direction lower than the thrust in the opening direction exertable by the ejecting means 16.

Preferentially, the retaining means 17 are configured for exerting the above-mentioned retaining action for a short sliding stroke in the opening direction of the drawer, shorter than the stroke in which the ejecting means 16 are active. In this manner, it is possible to limit the magnitude of the thrust that must be exerted by the ejecting means 16 to open the drawer, thereby also limiting possible misalignment of the drawer 13 during the first opening stroke owing to the presence of the ejecting means 16 only on one side of the piece of furniture.

In the preferential embodiment illustrated in FIGS. 1 to 6, the ejecting means 16 comprise a slider 18 linearly movable along a base body 19 and at least a thrust spring 20 connected at one end with the slider 18 and at the other end with a base body 19 so as to be loaded by the movement of the slider 18.

The locking means instead preferentially comprise a hooking member 21, for example in the form of a shaped wire hook, movably, particularly oscillatingly, supported at one end by the slider 18 and engaged at the other end in a heart-shaped path 22 provided on the base body 19 of the ejecting means 16.

As illustrated in FIGS. 1 to 6, the retaining means 17 preferentially comprise a slider 23 that oscillates and slides longitudinally in a slide track 29, biased by a traction spring 24 acting in the closing direction of the drawer 13, the slider 24 thereof being operatively connectable to the drawer 13 at the closing position of the drawer 13.

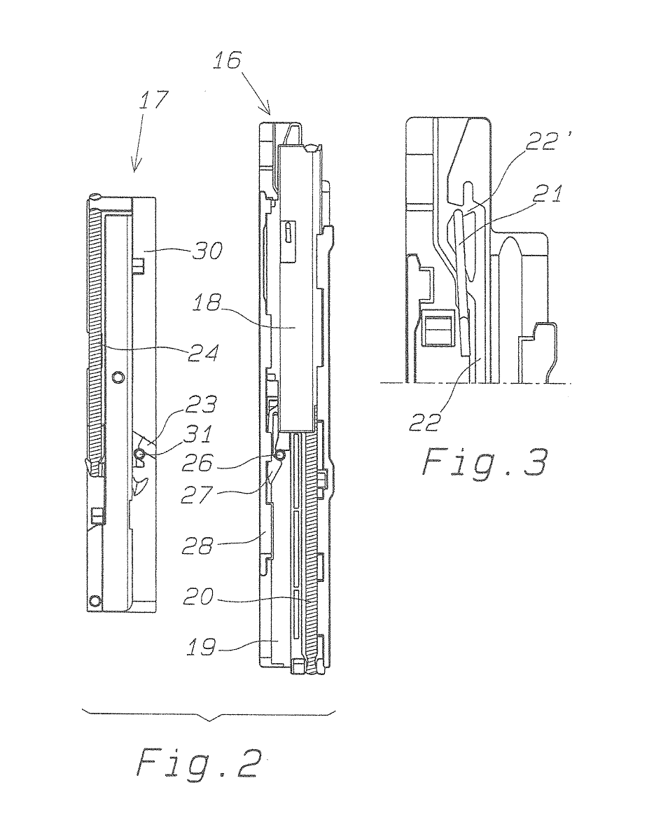

The operation of the piece of furniture with the system made up of the ejecting means 16 and the retaining means 17 for the drawer shall now be described with reference to FIGS. 2 to 6.

More specifically, FIGS. 2 and 3 refer to the closed state of the drawer 13 wherein the front part 13′ of the drawer 13 is arranged at a preset distance, for example at about 3 mm, from the side walls 11, 12 of the piece of furniture. In this state, the slider 18 of the ejecting means is in a retreated position toward a rear wall 25 of the piece of furniture, wherein the thrust spring 20 is tensile-loaded, and kept in this position by the locking hook 21 engaged in an anchor seat 22′ provided along the heart-shaped path 22.

In this position, the slider 18 of the ejecting means is operatively connected with the drawer 13, for example by means of a first driving pin 26 solidly constrained to an unillustrated part of the pull-out guide 14 fixed to the drawer and engageable by a flexible tab 27 of the slider 18, the tab 27 being kept in a folded position of engagement by the action of a side wall 28 of the base body 19.

As regards the retaining means 17, in the closed state of the drawer 13, the tiltable slider 23 is arranged in a retreated position along a longitudinal section of a slide track 29 afforded in a body 30 of the retaining means 17 for the slider 23 and is biased in the closing direction of the drawer 13 by the traction spring 24, in such a manner as to maintain the front part 13′ of the drawer properly in the desired closing position.

In this position, the tiltable slider 23 is operatively connected with the drawer 13, for example by means of a second driving pin 31 solidly constrained to an unillustrated part of the pull-out guide 15 fixed to the drawer on the respective side and engageable in a suitable lateral seat of the slider 23 by means of oscillating movement thereof, as explained below.

Alternatively, the driving pins cited hereinabove may be solidly constrained to the drawer, or, in the case in which the ejecting means and the retaining means are fixed to the side walls of the drawer 13, the driving pins may be fixed or solidly constrained to the walls 11, 12 of the piece of furniture laterally arranged to the drawer 13.

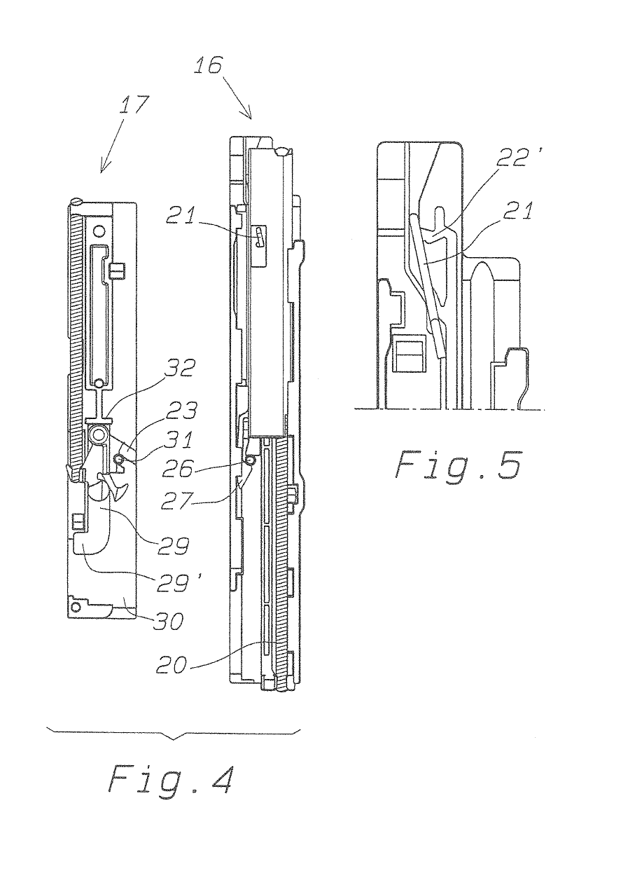

For the purpose of keeping the front part 13′ of the drawer 13 parallel and at a preset, uniform distance from the body of the piece of furniture by the closing position of the drawer, with particular reference to the side walls 11, 12 of the piece of furniture, there is preferentially provided a distancing stop, arranged on the side of the retaining means 17; in the case of the retaining means 17 illustrated in FIGS. 1 to 6, the distancing stop is preferentially constituted by a jut or projection 32 provided on the body 30 of the retaining means 17 and against which the tiltable slider 23 stops at the retreated position thereof, as is more clearly shown in FIG. 4.

In any case, other alternative embodiments are not excluded for the distancing stop, for example by configuring the latter in the form of a separate element, mounted on the body of the piece of furniture in a projecting manner on the side on which the retaining means 17 are arranged, and intended to come into contact with the front part 13′ of the drawer.

Again, as concerns the operation of the piece of furniture, for the purpose of opening the drawer 13 arranged in the closing position described hereinabove, the user must push the front part 13′ of the drawer 13, so as to bring about a retreat of the slider 18 of the ejecting means 16 and a consequent unhooking of the locking hook 21 from the anchor seat 22′ provided along the heart-shaped path 22, as illustrated in FIGS. 4 and 5.

As the ejecting means 16 are arranged on only one side of the piece of furniture, the user's push on the front part of the drawer proves to be effective and sufficient to bring about the required retreat of the slider 18, with the resulting unhooking of the locking hook 21, if the push is made in a position slightly beyond the retaining means 17, but more preferentially in a position shifted more toward the centre line of the front part 13′, and still more preferentially toward the side provided with the ejecting means 16.

If instead the push is made exactly on the side provided with the retaining means 17, it will not lead to the activation of the ejecting means 16 arranged on the opposite side of the drawer. In this case, the drawer 13 will remain closed, preventing, however, a faulty partial movement on only one side thereof.

Therefore, in the piece of furniture according to the invention, based on the position in which the push is made on the front part 13′ of the drawer, proper opening of the drawer 13 will be achieved or the drawer will remain closed, thereby preventing malfunction.

Although the ejecting means are arranged on only one side of the piece of furniture, the release of the ejecting means is sufficient to overcome the action of the retaining means arranged on the opposite side, thus permitting the opening of the drawer without problems or the risk of breakage.

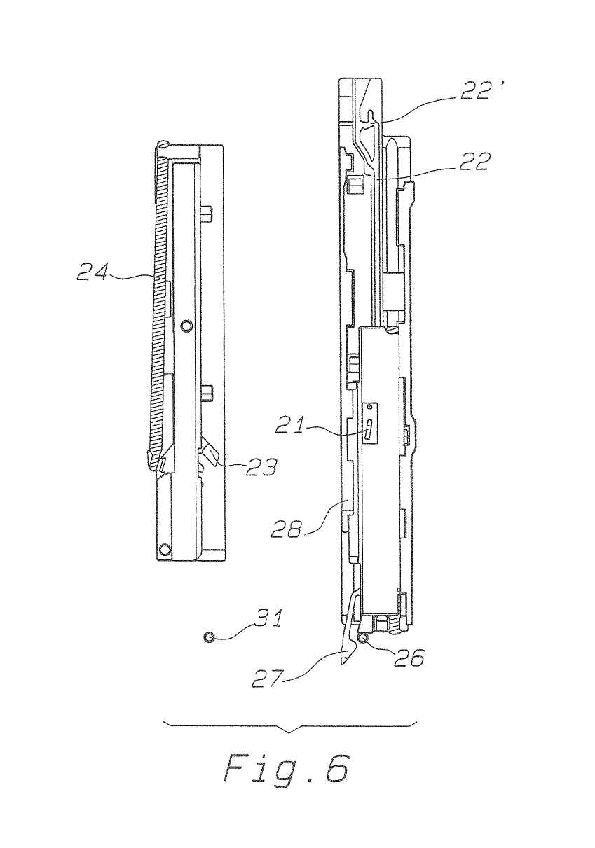

Once the slider 18 is freed from the locking action of the hook 21, as illustrated in FIG. 6, the tensile-loaded spring 20 can release and thus exert the thrust in the opening direction, bringing the slider 18 forward together with the driving pin 26 and the drawer 13 solidly constrained thereto, for a brief stroke, for example by about 5 cm, until the flexible tab 27, once the side wall 28 of the base body 19 is passed, is free to open so as to release the driving pin 26 and enable the user to complete the opening of the drawer 13 manually.

In the meantime, at least the first part of the opening movement of the drawer 13 caused by the slider 18 of the ejecting means 16, is transmitted to the tiltable slider 23 of the retaining means 17, which is advanced along the slide track 29, loading the traction spring 24 until reaching a curved section 29′ wherein the slider 23 undergoes oscillation capable of freeing the second driving pin 31, the slider remaining locked in this rotated position by action of the spring 24 until the drawer 13 is closed again.

In fact, to reclose the drawer 13, the user must push the drawer 13 in the closing direction, the push being capable of bringing about, by means of the movement of the first driving pin 26, a retreat of the slider 18 and the resulting tensile-loading of the opening spring 20 of the ejecting means 16, until the locking hook 21 is brought back into engagement in the anchor seat 22′ provided along the heart-shaped path. In the meantime, the retreating movement of the second driving pin 31 leads the slider 23 of the retaining means 17 to carry out an oscillating movement capable of having it disengage from the curved section 29′ of the slide track 29 and then return to the retreated retaining position of the drawer 13 under the effect of the traction of the spring 24.

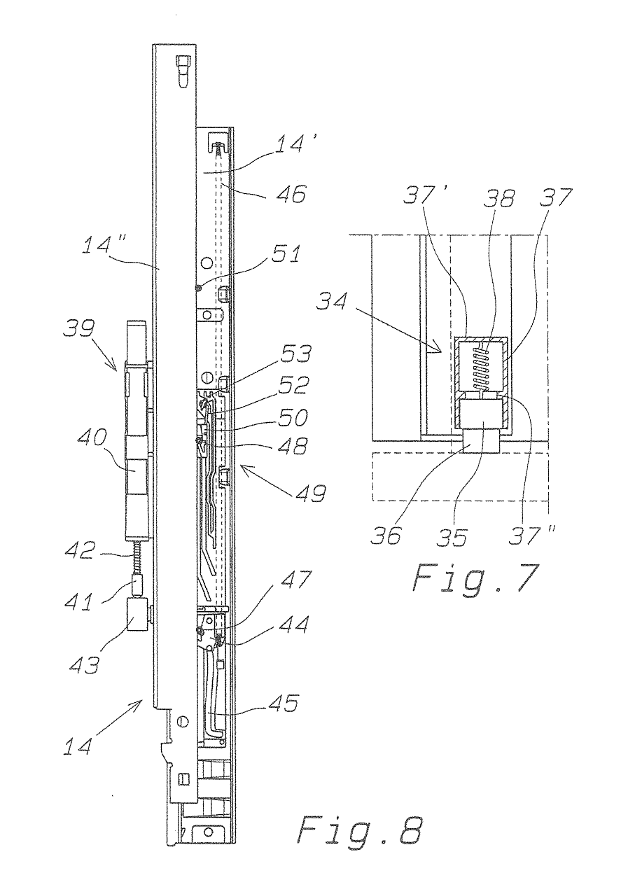

As an alternative to the preferential retaining means described previously, it is possible to provide for the use of magnetic retaining means 34, such as those shown in schematic form in FIG. 7. These magnetic retaining means 34 comprise at least one magnetic retaining element 35 fixed to the side wall 12 of the piece of furniture or to the pull-out guide 15 solidly constrained to the side wall 12, and a second retaining element 36 that is fixed to the front part 13′ of the drawer 13, the second element 36 alternatively being a second magnetic element or a ferromagnetic element that are engageable or disengageable with the magnetic element 35.

In any case, a reversed arrangement of the retaining elements 35, 36 on the body of the piece of furniture and on the front part of the drawer is not excluded.

For the purpose of preventing undesired disengagement of the retaining elements 35, 36, caused for example by the front part 13′ of the drawer rebounding at the end of the reclosing movement of the drawer, at least one of the retaining elements 35, 36 is preferentially supported in an elastically yielding manner in the opening direction of the drawer 13.

To that end, as illustrated in FIG. 7, the retaining element 35 is slidingly supported by a body 27 and there is provided a traction spring 38 connecting the retaining element 35 with a rear wall 37′ of the body 37. The traction spring 38 proves to be preloaded so as to bias the retaining element 35 against a stop 37″ provided by the body 37, enabling, in any case, sliding in the opening direction under the elastic effect of the spring 38.

According to an additional embodiment of the invention, the ejecting means may be operatively associated with closing means for the drawer, which also define the releasable locking means for the ejecting means, in which the ejecting means and the closing means are selectively loadable and activatable for generating a thrust in the opening direction starting from the closing position of the drawer and respectively a thrust in the closing direction during the last stretch of the closing movement of the drawer.

By way of example, in FIG. 8 a known solution of this type is illustrated. This solution comprises a combined ejection and deceleration device 39 in the form of a deceleration cylinder 40 with fluid and that is applied to a fixed part 14′ of the pull-out guide 14 for the drawer, the fixed part 14′ being fixed to the side wall 11 of the piece of furniture. The cylinder 40 has a piston rod 41 on which there is provided an ejector spring 42, the rod 41 of which is conformed and arranged for interacting with a striker element 43 that is applied to the movable part 14″ of the pull-out guide 14, starting from a stretch of the movement of the drawer 13 in proximity to the closing position of the drawer.

There are also provided means for closing the drawer that comprise a first slider 44 that is slidable along a slide track 45 applied to the fixed part 14′ of the pull-out guide 14. The slider 44 is biased by a spring 46 acting in the closing direction of the drawer with a force greater than that exertable in the opening direction by the ejector spring 42; the slider 44 and the slide track 45 are suitably conformed for enabling a selective transverse movement of the slider 44 capable of engaging or disengaging it in sequence with/from a first and a second driving pin 47, 48 solidly constrained to the movable part 14″ of the pull-out guide 14 for the drawer.

In particular, the slider 44 is movable between a first starting position of engagement with the first pin 47, in which the closing spring 46 keeps the drawer closed, a second position shifted crosswise after the front part of the drawer is pressed by the user and in which the slider 44 disengages from the first pin 47 to enable the ejector spring 42 to open the drawer, and a third position of engagement with the second pin 48 and in which the closing spring 46 can be reloaded by manual opening the drawer on the part of the user so that the automatic reclosing of the drawer can then be carried out by the closing spring 46, which prevails over the opening spring 42.

In this solution, there may also be preferentially provided a supplementary device 49 to enable re-establishment of the proper closing of the drawer in the case in which due to a limited opening of the drawer, the closing spring 46 is not suitably reloaded; in a known embodiment, this device 49 may for example comprise a second slider 50 that is movable by means of engagement with the second driving pin 48 and a third, additional driving pin 51, the slider 50 of which has a hooking member 52 that is selectively lockable in a suitably shaped locking track 53.

This solution, which provides ejecting means that are operatively associated with closing means, is of a known type and is therefore not described in detail herein. It is sufficient to note that the action thereof, for the purposes of the present invention, is replaceable with that of the ejection device described hereinabove. Lastly, a possible improvement in the piece of furniture according to the invention consists in providing a rotatable and/or slidable rest element, for example in the form of a wheel 54 rotatably supported by a small plate 55, fixable at a rear lateral area of the drawer 13 and having a rest surface conformed and arranged for remaining in contact with the surface of the side wall 11 of the piece of furniture at which the ejecting means 16 is arranged. This makes it possible to limit further any possible misalignment of the drawer 13 during the first opening stroke due to the presence of the ejecting means 16 on only one side of the piece of furniture.

As is evident from the above, owing to the suitable configuration and arrangement of the ejecting means and the retaining means according to the present invention, partial or faulty opening of the drawer is prevented, with a solution that is simple in construction, economical and easy to mount.

The piece of furniture with a drawer according to the invention is in any case susceptible to modifications and variants falling within the scope of the inventive concept; moreover, the construction details are replaceable with technically equivalent elements.

1. A piece of furniture (10) having at least one drawer (13) pullable out from the body of the piece of furniture, the piece of furniture (10) comprising:
a first and a second wall (11, 12) laterally arranged to the drawer (13), respectively provided with a first and a second pull-out guide (14, 15) for said drawer (13), and
ejecting means (16; 42) conformed and arranged for generating a thrust in an opening direction on the drawer (13), and
releasable locking means (21, 22; 44, 46) for locking said ejecting means (16; 42) in a closing position of the drawer (13),
said ejecting means (16; 42) with the relevant locking means (21, 22; 44, 46) being provided at only one (11) of said walls (11, 12) of the piece of furniture (10) laterally arranged to the drawer (13),
wherein retaining means (17; 34) are provided at the other one (12) of said walls (11, 12) of the piece of furniture (10) laterally arranged to the drawer (13), said retaining means (17; 34) being conformed and arranged for retaining said drawer (13) in the closing position.

2. (canceled)

3. The piece of furniture (10) according to claim 1, wherein said ejecting means (16; 42) with the relevant locking means (21, 22; 44, 46) are applied to the pull-out guide (14) provided on said wall (11) of the piece of furniture (10) at which the same means (16) are arranged.

4. The piece of furniture (10) according to claim 1, wherein said ejecting means (16; 42) with the relevant locking means (21, 22; 44, 46) are directly applied to said wall (11) of the piece of furniture (10) or to a first side wall of the drawer (13).

5. The piece of furniture (10) according to claim 1, wherein said retaining means (17;34) are applied to the pull-out guide (15) provided on said other wall (12) of the piece of furniture (10) laterally arranged to the drawer (13).

6. The piece of furniture (10) according to claim 1, wherein said retaining means (17; 34) are directly applied to said other wall (12) of the piece of furniture (10) laterally arranged to the drawer (13) or to a second side wall of the drawer (13).

7. The piece of furniture (10) according to claim 1, wherein said retaining means (17; 34) are configured for exerting a retaining action in the closing direction lower than said thrust in the opening direction exertable by said ejecting means (16).

8. The piece of furniture (10) according to claim 7, wherein the retaining means (17; 34) are configured for exerting said retaining action for a stroke shorter than the stroke in which said ejecting means (16; 42) are active.

9. The piece of furniture (10) according to claim 1, claims, wherein said locking means (21, 22; 44, 46) for the ejecting means (16; 42) are releasable by pressing the drawer (13) in the closing direction.

10. The piece of furniture (10) according to claim 1, wherein said ejecting means (16) comprise a slider (18) linearly movable along a base body (19) and at least a thrust spring (20) loadable by said slider (18).

11. The piece of furniture (10) according to claim 10, wherein said locking means (21, 22) comprise a hooking member (21) movably supported by said slider (18) of the ejecting means (16), said hooking member (21) being engageable in a heart-shaped path (22) provided on the base body (19) of the ejecting means (16).

12. The piece of furniture (10) according to claim 1, wherein said retaining means (17) comprise a tiltable slider (23) biased by a traction spring (24) acting in the closing direction of the drawer (13), said slider (23) being operatively connectable to the drawer (13) at the closing position of the drawer (13).

13. The piece of furniture (10) according to claim 1, wherein said retaining means (34) comprise magnetic retaining means (35, 36).

14. The piece of furniture (10) according to claim 13, wherein said magnetic means (35) are supported in an elastically yieldable way in the opening direction of the drawer (13).

15. The piece of furniture (10) according to claim 12, further comprising a distancing stop (32) for the drawer (13), said stop (32) being conformed and arranged on the side of said retaining means (17) for keeping the drawer (13) at a preset distance from the body of the piece of furniture by the closing position of the same drawer (13).

16. The piece of furniture (10) according to claim 1, wherein said ejecting means (42) are operatively associated with closing means (44, 46) for the drawer (13) further defining said releasable locking means, said ejecting means (42) and said closing means (44, 46) being selectively loadable and activatable for generating a thrust in the opening direction starting from the closing position of the drawer (13) and respectively a thrust in the closing direction during the last stretch of the closing movement of the drawer (13).

17. The piece of furniture (10) according to claim 1, wherein at least a rotatable and/or slidable rest element (54) is provided and is fixable at a rear lateral area of the drawer (13), said rest element (54) having a rest surface conformed and arranged for remaining in contact with the surface of the side wall (11) of the piece of furniture at which the ejecting means (16; 42) is arranged.
